(19) United States
(12) Patent Application Publication
(10) Pub. No.: US 2014/0189839 A1
(43) Pub. Date: Jul. 3, 2014

(54) SINGLE SIGN-ON METHODS AND APPARATUS THEREFOR

(71) Applicant: Michal Jezek, San Jose, CA (US)

(72) Inventor: Michal Jezek, San Jose, CA (US)

(21) Appl. No.: 13/794,484

(22) Filed: Mar. 11, 2013

Related U.S. Application Data
(60) Provisional application No. 61/747,872, filed on Dec. 31, 2012.

(51) Int. Cl. H04L 29/06

(52) U.S. Cl. CPC H04L 63/0815
USPC 726/8

(57) ABSTRACT

Embodiments of the invention employ a KUSO (Kerio Unity Sign On) server to work with different web services (which offer online service via to users via user accounts) to offer single sign-on capability to different services. With the use of the KUSO server, a user only has to authenticate with one of the web services in order to have authenticated access to all web services. After the first successful authentication at one of the web services, the web server that successfully authenticates the user communicates the successful authentication with the KUSO server using a special channel and a special token. Subsequently authentication verification is performed transparently by the KUSO server if the user wishes to access any of the other web services. Safeguards for various edge conditions during sign-on and sign-offs are provided to improve security.

### PRIORITY CLAIM

The present application claims priority under 35 USC 119(e) to a commonly owned provisional patent application entitled “SINGLE SIGN-ON METHODS AND APPARATUS THEREFOR”, Application No. 61/747,872, filed in the USPTO on Dec. 31, 2012 (Attorney Docket No. KRIO-P002P1) and incorporated herein by reference.

### BACKGROUND OF THE INVENTION

Single sign-on (SSO) refers to technology that allows a user to log in (i.e., provide user name and password or some other credentials) to one account and subsequently has access to other accounts without the need to explicitly logging in to the other accounts.

Online services have existed for some time. Depending on the service offered, a user having an account with an online service may log in to shop or to do work or to email, or to access a database, etc. FIG. 1 shows an example SSO arrangement in which a user 102 logs in (109) to a web service account provided by server 104. The account provided by server 104 may be for example, an email account. After user 102 successfully logs in to the account provided by server 104 (by for example providing userid/password or some other form of authentication), user 102 may access (107 and 109) other web service accounts without having to provide credentials. For illustration purpose, these other web service accounts are provided by servers 106 and 108 respectively.

It should be understood that for the purpose of SSO, accounts offered by server 106, 108, and 104 may be offered by different entities or organizations that do not cooperate to cross-authenticate. SSO provides this cross-authentication capability among accounts offered by entities or organizations that may not even be aware of the existence of one another. Further, the fact that different web service accounts are provided by different servers are only illustrative. It should be understood that a single server may be used to offer different accounts/services provided by different entities and the term “server” encompass a single server, multiple servers, one or more server farms, virtual servers, actual servers, or any combination thereof.

Some existing SSO solutions (such as by Kerberos) require configuration of client and server software. Configuring client operating system may not be possible in some situations, such as for a visiting worker using a guest computer or for a traveler using a for-hire public internet facility (commonly known as internet café). Configuring server operating system may not be possible as many service providers are unwilling or unable to provide access to their operating system to facilitate such SSO-related configuration.

Other SSO solutions (such as by WebAuth) requires the user to sign on to WebAuth login server. This requirement poses a problem as some users may be reluctant to provide authentication data to a service (such as providing authentication data to the WebAuth login interface) that they are not familiar with. Further, WebAuth requires the user to log out each account individually or to destroy all cookies.

Still further, some prior art SSO solutions require a direct connection between the user client and the SSO authentication server. If the SSO authentication server fails, it may not be possible to sign on to the individual services (such as email, shopping, or database access) individually even though such services are still available to those not utilizing the prior art SSO solutions.

For these reasons and others, improved SSO solutions are desired.

### BRIEF SUMMARY OF THE INVENTION

An embodiment of the invention relates to a single sign-on method for enabling a user to perform authenticated sign-on to a plurality of websites associated with a plurality of web services. The method includes authenticating the user at a first website. The first website is associated with a first web service. The method also includes communicating the authenticating from the first website to a server if the authenticating is successful. The method further includes thereafter employing the server to authenticate the user if the user wishes to access a second website associated with a second web service different from the first web service.

The embodiment of the invention also relates to an arrangement for facilitating single sign-on by a user to a plurality of websites associated with a plurality of web services. The arrangement includes a first web server, wherein the web server being associated with a first website. The arrangement also includes a single sign-on server, the single sign-on server communicating with the first web server if the first web server successfully authenticates the user. The arrangement further includes a second web server associated with a second website, the second web server communicating with the single sign-on server, responsive to the user wishing to access the second website, to ascertain that the user has previously been successfully authenticated.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEW OF THE DRAWINGS

FIG. 1 shows an example SSO arrangement in which a user logs in to a web service account provided by server.

FIG. 2 shows, in accordance with one or more embodiments of the invention, a typical SSO scenario using the KUSO method.

FIG. 3 shows, in accordance with an embodiment of the invention, the steps with which the client handles an access request.

FIG. 4 shows, in accordance with an embodiment of the invention, the initial login to one of the participating web service.

FIG. 5 shows the steps of block 406 of FIG. 4 (show logon dialog/try to determine whether the browser can communicate with the KUSO server).

FIG. 6 shows, in accordance with an embodiment of the invention, in greater detail the steps involved in client interaction with the KUSO server (phase 2) as part of the initial logon (block 432 of FIG. 4).

FIG. 7 shows, in accordance with an embodiment of the invention, phase 3 of the initial logon when the client browser is redirected back to the accounting web service of the present example (block 514 of FIG. 6).

FIG. 8 shows, in accordance with an embodiment of the invention, phase 1 of the steps for automated logon.

FIG. 9 shows, in accordance with an embodiment of the invention, phase 3 of the automated login (see step 574 of FIG. 9) in greater details.

FIG. 10 shows, in accordance with an embodiment of the invention, the automated logout process.

FIG. 11 shows, in accordance with an embodiment of the invention, the steps involved in servicing a logout IMG request.

### DETAILED DESCRIPTION OF THE INVENTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

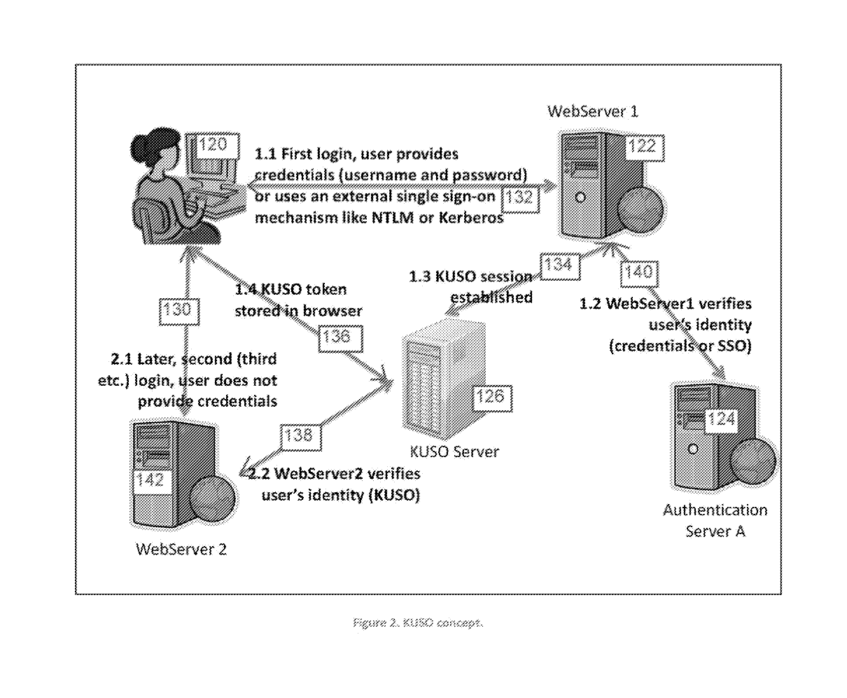

Embodiments of the invention employ a KUSO (Kerio Unity Sign On) server to work with different web services (which offer online service via to users via user accounts) to offer single sign-on capability to different services. A user only has to authenticate with one of the web services in order to have access to all web services. FIG. 2 shows, in accordance with one or more embodiments of the invention, a typical SSO scenario using the KUSO method. The user 120 first logins with one of the KUSO-participating web services 122 (provided by Webserver 1 in FIG. 2). The login may be performed using any login mechanism employed by web service 122, including proprietary or third party login solutions (such as LDAP) or even third party SSO solutions (such as for example NTLM by Microsoft Corporations or Kerberos or WebAuth). In this example, web service 122 employs Authentication Server A running authentication service 124 to authenticate the user on behalf of web service 122.

After the user successfully authenticates with web service 122 (which runs on webServer 1), Thereafter, web service 122 (such as an accounting web service) establishes a KUSO session 134 with KUSO application 126 executing on KUSO Server to inform KUSO application 126 that the user has successfully authenticated with one of the web services (e.g., web service 122 running on WebServer 1 in this case). In step 136, a KUSO special token is delivered to the user browser.

At a subsequent time, when user 120 wishes to login to another KUSO-participating web service 142 (such as email) executing on WebServer 2, the user does not need to provide authentication. Instead, web service 142 will provide the previously stored KUSO token to WebServer 2 (operation 130). Thereafter, WebServer 2 verifies the KUSO token (operation 138) with KUSO server. If the verification in operation 138 is successful, the user may simply begin using web service 142. From the user's perspective, no authentication step or data is required to access web service 142.

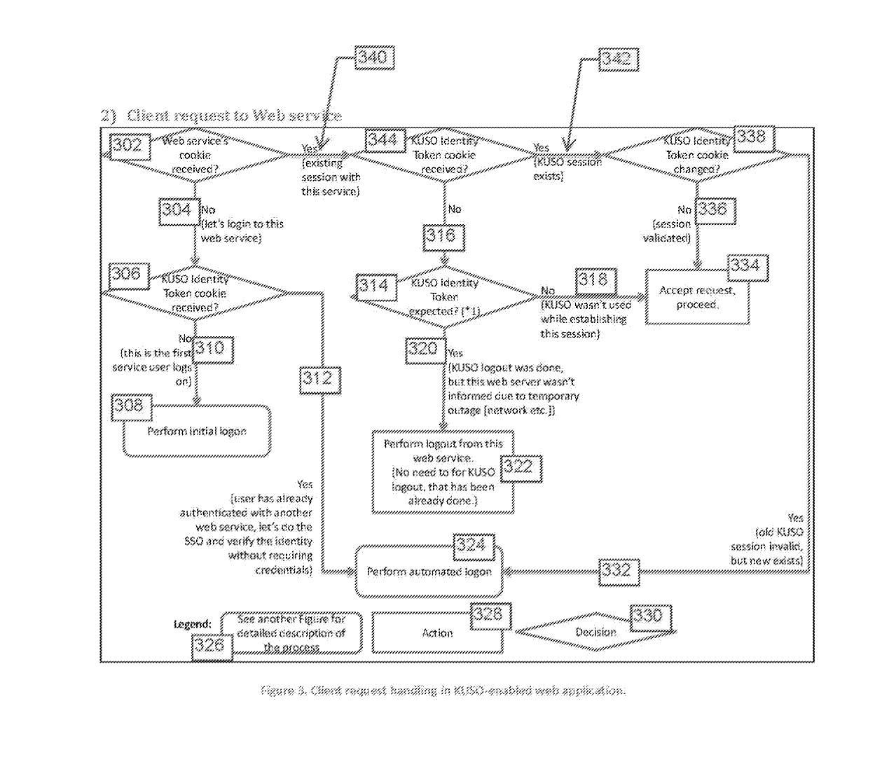

FIG. 3 shows, in accordance with an embodiment of the invention, the steps with which the client handles an access request (whether an initial login or automatic subsequent login if successful authentication has been performed with another web service). In this example, the user is attempting to access the KUSO participating web accounting service.

In step 302, it is ascertained whether accounting web service token (i.e., a token from this web service) has already been received. If the web service token has already been received, an existing session is deemed to exist with this web service (branch 340). On the other hand, if a web service token has no been received (path 304), the user is deemed to access this web service for the first time (since powering his computer on, for example).

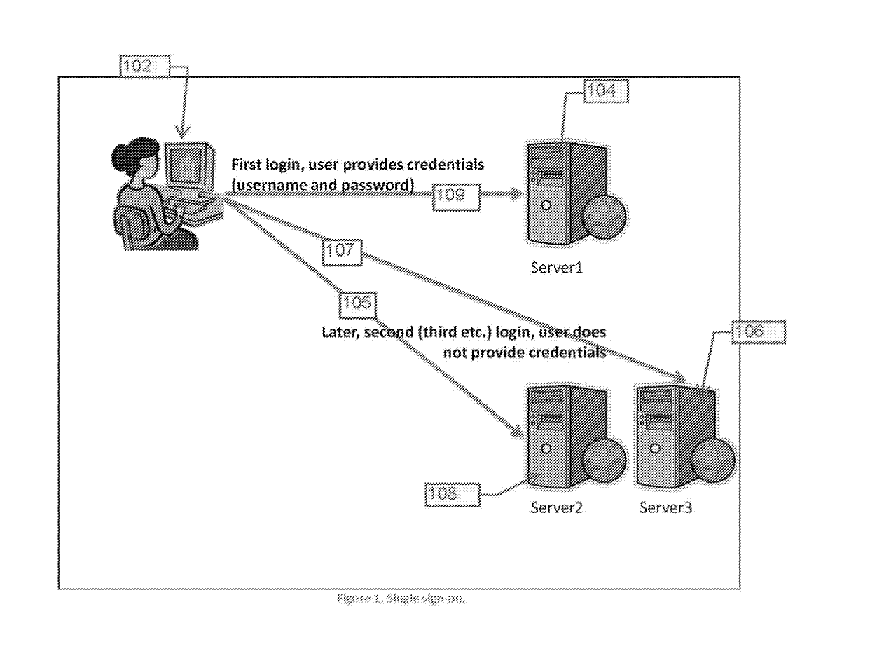

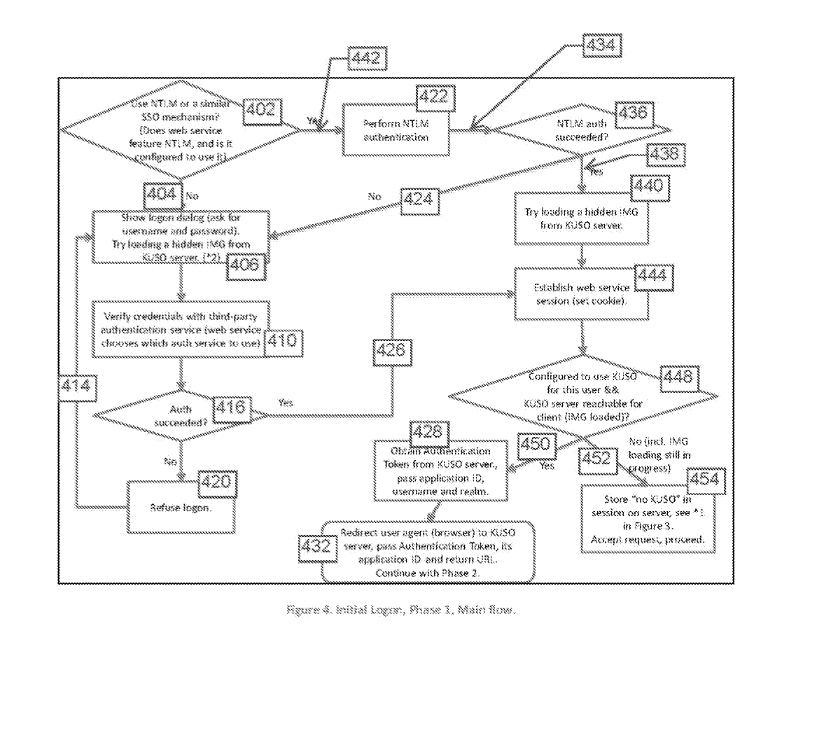

Suppose no web service token has been received (path 304), the user is deemed to want to login the web service. In step 306, it is ascertained whether the client has received a KUSO token (referred to earlier in step 136 of FIG. 1). If the client has not received the KUSO special token (path 310), the user is deemed to NOT have successfully authenticated with any other web services. In this case, the initial login (308) will be performed. This initial login step 308 will be discussed later in connection with FIG. 4 herein.

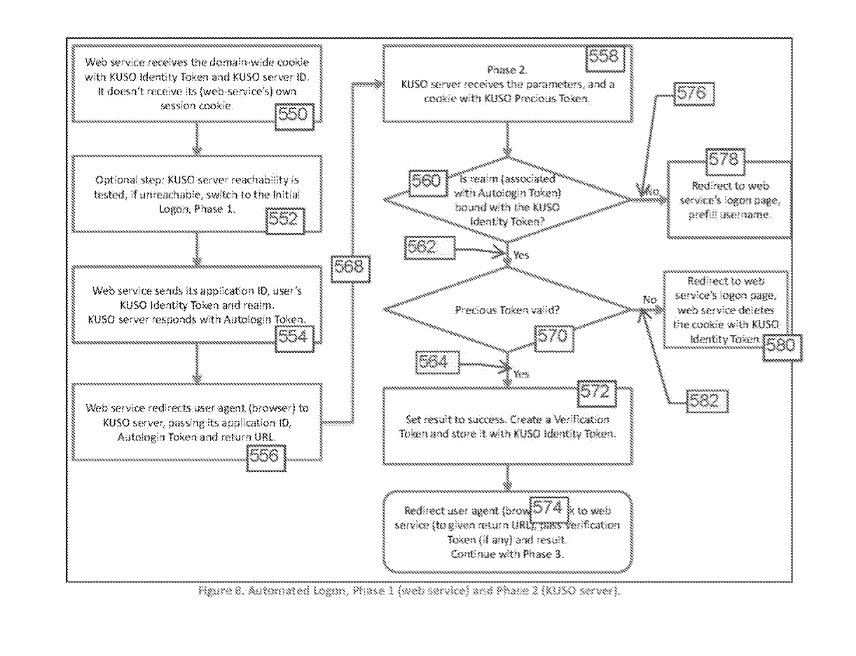

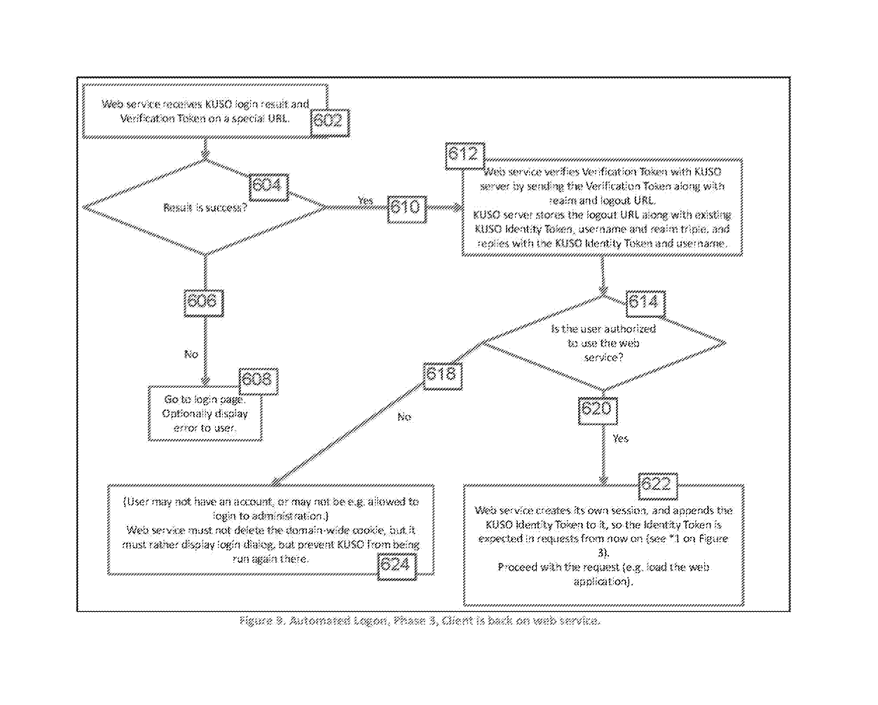

On the other hand, if the special KUSO token has been received (step 306 and path 312), the user is deemed to have successfully authenticated with another web service and KUSO server is able to provide automated login. In this case, automated login using KUSO methodology will be performed (step 324). Step 324 will be discussed later herein in connection with FIGS. 8 and 9.

Returning now to step 302, if the web service token has been received (step 302 and path 340), the user is deemed to have been in an existing session with this web service. In this case, step 344 checks to see if the KUSO cookie has been received. If the KUSO cookie has been received (branch 342), an existing session that involves KUSO automated login is deemed to exist. In step 338, a check is made to determine whether the KUSO token has been changed. If the KUSO token has been changed (branch 332), the old KUSO session is deemed valid but a new KUSO session exists. This may happen if the user logs off via another web service (e.g., CRM or Customer Relations Management web service) and ordinarily, the KUSO methodology would destroy/invalidate all existing KUSO tokens but for some reason, this accounting web service did not receive the invalidation request. Subsequently, the user may have successfully logged in using the CRM web service again, which causes the KUSO server to issue a new KUSO token to all participating web services. From the accounting web service perspective, the KUSO token has changed from the last time an access to the accounting web service was performed. In this case, the method proceeds to step 324 to perform automated KUSO login again.

On the other hand, if the KUSO token has not been changed (step 338 and branch 336), the access requested is accepted and service is provided to the client.

Returning to step 344, if a KUSO cookie is not received (branch 316) and a KUSO cookie is not expected (step 314 and branch 318), it is deemed that an existing session existed but KUSO is deemed to not have been involved in the login to the accounting web service. This may happen if, for example, the accounting web service decides not to use single sign on via KUSO for this user for some reason (such as per accounting web service policy for this user or due to KUSO server failure during log in). In this case, the user is provided with accounting service via step 318.

Returning to step 344, if a KUSO cookie is not received (branch 316) and a KUSO cookie is expected (step 314 and branch 320), a KUSO log out is deemed to have been performed with another KUSO-participating web service (such as CRM) but this accounting was not informed due to, for example, network failure or some other cause. In this case, it is dangerous to allow the user to proceed since this user making the request to the accounting web service may not be the authentic user and the authentic user may have already logged out via KUSO and assumed that the accounting web service has been automatically logged out and may have physically left the computer terminal after the assumed KUSO log out, for example. In step 322, the client logs out of the accounting web service to prevent a possible fraudulent use of the accounting web service.

FIG. 4 shows, in accordance with an embodiment of the invention, the initial login to one of the participating web service (step 308 of FIG. 3). This is the situation where the user has not successfully authenticated himself with any of the KUSO-participating web service and is performing the initial login with one of the KUSO-participating web services. For the purpose of the present example, assume the user is attempting to login with the accounting web service.

In step 402, it is ascertained whether the web service employs another SSO service (such as Microsoft's NTLM and although NTLM is used as an example, the invention covers the case where the web service uses other SSO solutions as well). If yes (branch 442), the other SSO service (e.g., NTLM) is performed in step 422. If NTLM sign on is successful (step 436 and branch 438), the method proceeds to step 440 to determine whether the client can reach the KUSO server. In the example of FIG. 4, the client does so by attempting to load a hidden image from KUSO server. Although the hidden image technique (acquiring an image from the KUSO server that is not generally visible to the user at the client) is employed, any technique to attempt to determine whether the KUSO server can communicate with the client can also be used without departing from the scope and spirit of the invention.

In step 444, the web service session is established and the web service cookie is set.

In step 448, it is ascertained whether KUSO single sign on is enabled for this user and whether the KUSO server is reachable (as determined in step 440 above). If yes (branch 450), the accounting service obtains the authentication token from the KUSO server (step 428) using a secure channel (such as https) and also passes the application ID, username, and realm to the KUSO server. This is part of the operation of step 134 of FIG. 2.

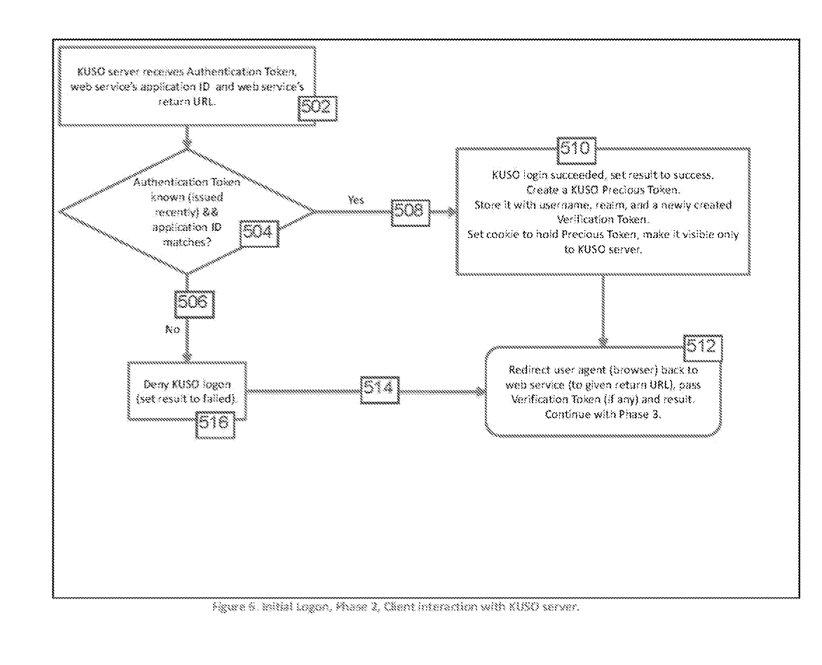

In step 432, the accounting web service redirect the client browser to KUSO server, passes the authentication token, the accounting web service application ID, and the return URL (to allow the KUSO server to redirects the client back to the accounting web service). These are a part of the operations of steps 132 and 136 of FIG. 2. From step 432, phase 2 of the initial login continues on FIG. 6 hereinbelow.

On the other hand, if the KUSO single sign on is not enabled for this user or the KUSO server is not reachable (as determined in step 440 above), the method proceeds to step 454 to store a “NO KUSO” flag on the accounting web server and allows the service to be provided. Note that even if KUSO single sign on is enabled but for some reason, KUSO is not reachable by the client, embodiments of the invention advantageously allow the service to be provided to this user. In this manner, KUSO does not represent a bottleneck or a failure point so as to impede user access if the accounting web service is in fact available. Thus KUSO is not involved in the login (see step 314 and path 318 of FIG. 3 for the situation where the “NO KUSO” flag allows the determination of whether a KUSO token is expected).

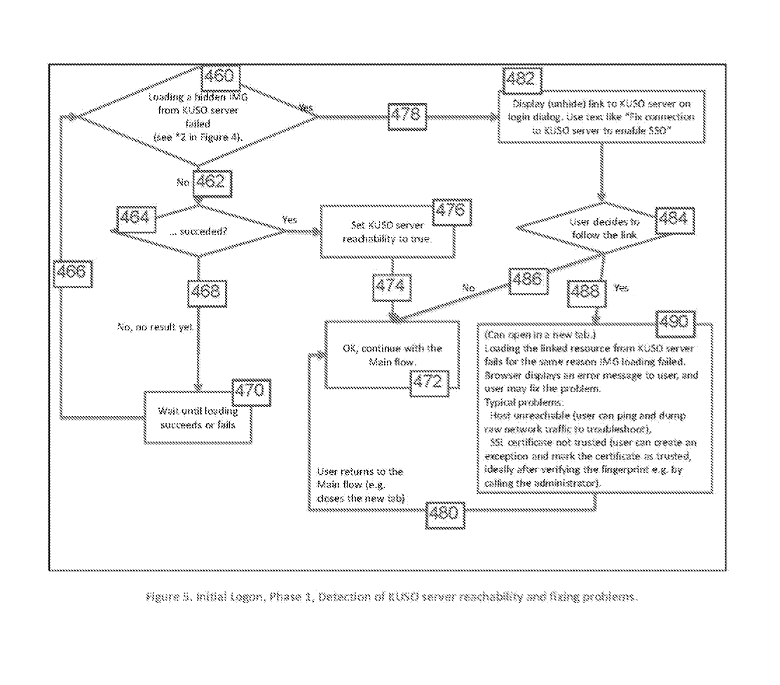

Returning to step 402, it is ascertained that the web service does not employ another SSO service (such as Microsoft's NTLM), the method proceeds to step 406 wherein the accounting web service provides its own authentication dialog to ask the user for authentication (e.g., userid and password). While the user provides his authentication, an attempt is made to determine whether the client can communicate with the KUSO server. Again, although the hidden image technique is employed, other techniques may also be employed to make the determination. Step 406 is also performed if the other existing SSO service (such as NTLM) does not succeed (step 436 and branch 424). FIG. 5 discusses some operations involved in step 406 in greater detail.

In step 410, the authentication credentials supplied by the user in step 406 is verified. The verification may be done by, for example, a third party authentication service pre-selected by the accounting web service. If the user identity is not verified (not authenticated in step 410), the user is asked to attempt to login again via the web service own logon screen.

If the user identity is verified (authenticated per step 410), the method proceeds to step 444 to establish the KUSO session so that the KUSO server can automate the login process for other KUSO-participating service and to enable the subsequent automated log-off for all KUSO-participating web services if the user logs off at any of the KUSO-participating web services.

FIG. 5 shows the steps of block 406 of FIG. 4 (show logon dialog/try to determine whether the browser can communicate with the KUSO server). In step in greater detail. In this example, the hidden image technique is employed although, as mentioned, other techniques for determining whether the browser can communicate with the KUSO server. In step 460, it is ascertained whether the browser client can load the hidden image from the KUSO server. If the hidden image cannot be loaded (branch 478), the method proceeds to block 482 to issue a warning/instruction to the user to request the user to fix the connection to KUSO to enable the SSO service. The link to the KUSO server may be unhidden to inform the user of the failed link.

If the user decides to follow the link (block 484 and path 488), the method proceeds to step 490 to implement corrective steps to attempt to communicate between the browser and the KUSO server. In an example, a linked resource is explicitly attempted to be loaded from the KUSO server in step 490. If the link resource cannot be loaded for the same reason, the browser may then display the error message to the user to allow the user to take corrective action. For example, if the browser returns an error message that indicates that the host is unreachable, the user may ping and dump raw network traffic to attempt to troubleshoot the network problem. As another example, if the browser returns an error message that indicates that the SSL certificate is not trusted, the user may be given an opportunity to create an exception and proceed. Thereafter, the method proceeds (path 480) to continue with the main flow of FIG. 4 (which may be 410, 452 or 450).

On the other hand, if the user decides not to follow the link (block 484 and path 486), the method proceeds to block 472 to continue with the main flow of FIG. 4 (which may be 410, 452 or 450).

Returning to block 460, if the hidden image loading of block 460 has not failed, the method proceeds on path 462 to determine whether the hidden image loading actually succeeded (block 464). If image loading succeeded, the method proceeds to block 476 to set the KUSO server reachability flag to true (the KUSO server reachability flag is initially set to false as an initial condition prior to step 476). Thereafter, the method proceeds (path 474) to continue with the main flow of FIG. 4.

On the other hand, if the hidden image loading has not completed (block 464 and path 468), the method proceeds to block 470 where it may wait until loading is completed or may fail the hidden image loading attempt either immediately or after a timeout period. Thereafter, the method returns to block 460 (path 466).

FIG. 6 shows, in accordance with an embodiment of the invention, in greater detail the steps involved in client interaction with the KUSO server (phase 2) as part of the initial logon (block 432 of FIG. 4). In step 502, the request from the client browser is redirected from the initial login web service (such as the accounting web service of the present example) to the KUSO server. The requests sent to the KUSO server from the web service server may include the authentication token (which was issued earlier in step 428 by the KUSO server), the accounting web service application ID, and the web service's return URL.

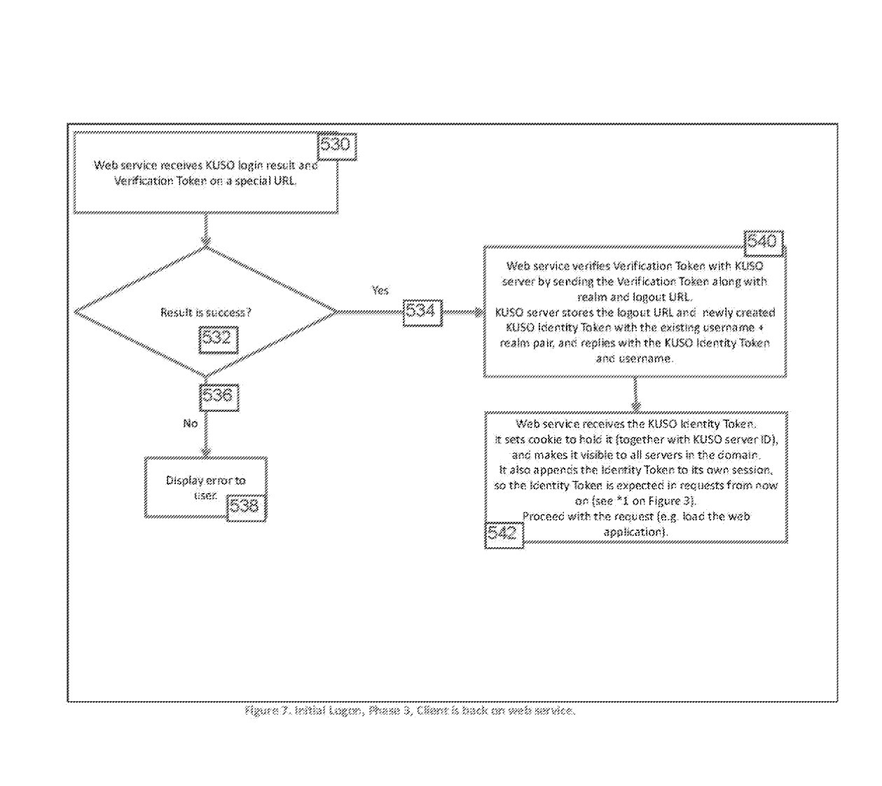

If the check by the KUSO server shows the authentication token is not known/current or the application ID does not match the authentication token (block 504 and path 506), the method proceeds to step 516 where it is deemed that the KUSO login attempt has failed and the KUSO login flag is set to fail). The method then proceeds to block 514 to redirect the user client (browser) back to the web service (to given return URL), pass the verification token (if any) and result (which would be false due to step 516). The steps of block 514 will be discussed in greater detail in FIG. 7 herein.

On the other hand, if the check by the KUSO server shows the authentication token is known/current and the application ID matches the authentication token (block 504 and path 508), the method proceeds to step 510, where it is deemed that the KUSO login has succeeded. The KUSO login result flag is set to “success” and a KUSO precious token (KUSO identity token) is created. The KUSO precious token is stored with the user name, the realm, and the newly created verification token (which is created by the KUSO server). The method then sets the cookie of the client browser to store the KUSO precious token in a manner that makes the KUSO identity token cookie visible only to the KUSO server. In this manner, the KUSO identity token cookie is only passable between the client browser and the KUSO server and unreachable/inaccessible by any other server/entity. This KUSO identity token cookie is employed for subsequent automated login of other participating web services.

The method then proceeds from block 510 to block 514 to redirect the user client (browser) back to the web service (to given return URL), pass the verification token (which would be available from block 510) and the KUSO login result (which would have been set to success in block 510). The steps of block 512 will be discussed in greater detail in FIG. 7 herein.

FIG. 7 shows, in accordance with an embodiment of the invention, phase 3 of the initial logon when the client browser is redirected back to the accounting web service of the present example (block 514 of FIG. 6). In step 530, the accounting web service receives the KUSO login result (successful/not successful). If the KUSO login result is successful, the verification token is also received by the accounting web service from the client browser on the special redirect URL mentioned earlier.

If the KUSO result is not a success (block 532 and path 536), the method proceeds to display a message to the user to inform the user of KUSO login failure. On the other hand, if KUSO result is a success (block 532 and path 534), wherein the accounting web service in block 540 verifies the verification token with the KUSO sever by sending the verification token along with the realm and the logout URL (which is used later to logout the user). The KUSO server stores the logout URL and the newly created KUSO identity token that has the existing username and realm pair, and replies to the accounting web service with the KUSO identity token and user name.

In step 542, the accounting web service receives the KUSO identity token. The accounting web service then sets a cookie to hold the KUSO identity token together with the KUSO server ID (in case there are multiple KUSO servers) and makes it visible to all servers (that is expected/set to participate in KUSO login) in the domain. In this manner, future KUSO-participating web services interacting with this client would be aware of the KUSO initial login. The accounting web service also appends the KUSO identity token to its own session, such that the KUSO identity is expected in requests associated with the session (see block 314 of FIG. 3). Thereafter, the accounting web service may begin serving the client browser request (e.g., load the accounting web application).

FIG. 8 shows, in accordance with an embodiment of the invention, phase 1 of the steps for automated logon. This is the situation where the user has successfully login to the first KUSO-participating web service (e.g., the accounting web service in the present example) and now the user wishes to login to another web services (such as the Customer Relations Management or CRM web service). Since this is a single sign on solution, the user ideally does not have to provide credentials all over again when accessing the CRM web service. Generally speaking, in the first phase of the automated login, the client browser interacts with the CRM web service (in this example, the CRM web service represents the web service that the user wishes to access subsequent to a successful login to another KUSO-participating web service such as the accounting web service of the present example). In the second phase of the automated login, the client browser interacts with the KUSO server, and in the third phase (discussed in FIG. 9), the client browser interacts again with the CRM web server. FIGS. 8 and 9 discuss step 324 of FIG. 3 in greater detail (see also step 130 and 138 in FIG. 2).

Referring now to step 550 of FIG. 8, the CRM web service receives the domain-wide cookie with the KUSO identity token and the KUSO server ID. The CRM web service does not receive its own session cookie so it knows this is an automated login situation. In 552, there is an optional step to check whether the KUSO server is reachable by the client (e.g., using the hidden image technique displayed earlier or via another technique to verify accessible client browser-KUSO server communication). If the KUSO server is found to be unreachable, the method switches to initial login, Phase 1 (see FIG. 4) and attempts a local login to allow the user to access the CRM server even if the KUSO server is unreachable (step 552).

If the KUSO server is reachable, in step 554, the CRM web service sends to the KUSO server its application ID, the user's identity token that it receives from the client browser and the realm. The KUSO server receives and stores these parameters and responds with an autologin token (step 554). In step 556, the CRM web service redirects the client browser to the KUSO server and passes certain parameters to the client browser. Among the parameters passed from the CRM web service to the client browser are the application ID of the CRM web service, the autologin token, and the return URL to redirect at a later time the client browser to the CRM web service.

Phase 2 of the automated login starts at step 558. In step 558, the client browser interacts with the KUSO server. The KUSO server receives the parameters passed by the CRM web service to the client browser in step 556, and a cookie with the KUSO precious token from the client browser (this is the cookie that was sent to the client browser from KUSO server during the initial login to the accounting web service in step 510 of FIG. 6 and is accessible only by the KUSO server and not any other server).

In step 560, the method checks to see if the realm associated with the autologin token (see step 554) is bound with the KUSO identity token. If not (branch 576), the user is directed to the CRM web service login page and the method optionally prefills the user's username. The situation of path 576 and step 578 may happen if, for example, the user initially logins to the client application interface of a web service and now tries to login to another realm such as the administration interface of the same web service.

If the realms match per the check of step 560, the method proceeds to step 570 to determine if the KUSO precious token is valid by comparing the current KUSO precious token with the previously stored KUSO precious token. If the KUSO precious token has not changed, the KUSO precious token is verified (since the user knows the secret), and the method proceeds to step 572 (via path 564) to set the KUSO result to success and the KUSO server creates a verification token and store it with the KUSO identity token. In step 574, the KUSO server redirects the client browser to the CRM web service (using the return URL supplied earlier by the CRM web service) and pass the verification token (if any) and the KUSO result.

On the other hand, if the KUSO precious token is not valid (per the check of step 570), the client browser is redirected to the CRM web service logon page, and the CRM web service deletes the cookie with the KUSO identity token. This is the case where the user used the KUSO identity token but failed the KUSO precious token test with the KUSO server. In this case, for safety reason, the information about the KUSO session is invalidated.

FIG. 9 shows, in accordance with an embodiment of the invention, phase 3 of the automated login (see step 574 of FIG. 9) in greater details. In phase 3, the client browser is redirected back to the CRM server to complete the autologin and to begin using the client CRM web service application. In step 602, the CRM web service receives the KUSO login result and the verification token (see step 574) using the special URL that it supplied earlier.

In step 604, the CRM web service checks to see if the KUSO login result flag is successful. If the KUSO login is not successfully, the CRM web service displays (path 606 and step 608) the CRM own login page to allow the user to perform a local (non single-sign-on) login. This allows the user to access the CRM web service even if single sign on is not possible. Optionally, the user may be informed that KUSO login has failed.

If the KUSO login is successful (path 610), the method proceeds to step 612 wherein the CRM web service verifies the verification token (that it has just received) with the KUSO server by sending the verification token along with the realm and logout URL for the CRM web service (for later use) with the KUSO server via a secure channel. Verifying the verification token is one way to prove that the KUSO login is indeed successful.

KUSO server stores the logout URL (for later logout use) along with the existing KUSO identity token, username and realm, and replies to the CRM web service with the KUSO identity token and username.

In step 640, the CRM web service decides whether the user is actually authorized to use the CRM web application. Although KUSO is capable and reachable for automated login for the user with the CRM web application via KUSO single sign-on, there may be situations where the user does not have the authority to actually use the CRM web application. For example, the user may not have a valid account (e.g., not registered or non-payment) with the CRM web service or CRM administration. Other reasons may exist that cause the user to not have the authority to use the CRM web application. In this case (see step 624), the CRM web service does not delete the domain-wide cookie (so that the user may still KUSO to do automated logon to other KUSO-participating web services that the user may have a valid account with). However, the user is prevented by the CRM web service from using KUSO to sign on to the CRM web service again. Also in step 624, the CRM web service may display the CRM login dialog to allow the user to do local login via another username/password that may work with the CRM web service. The decisions of what to do with a user who failed the authorization step of step 614 is up to the policies of the particular web service.

If the user is authorized to use the CRM web service (path 620 and step 622), the CRM web service creates its own session and appends the KUSO identity token to it so that the KUSO identity token is expected in requests from that point on (see block 314 of FIG. 3). Thereafter, the CRM web service proceeds with providing the CRM web application functions to the client browser responsive to client browser requests and commands.

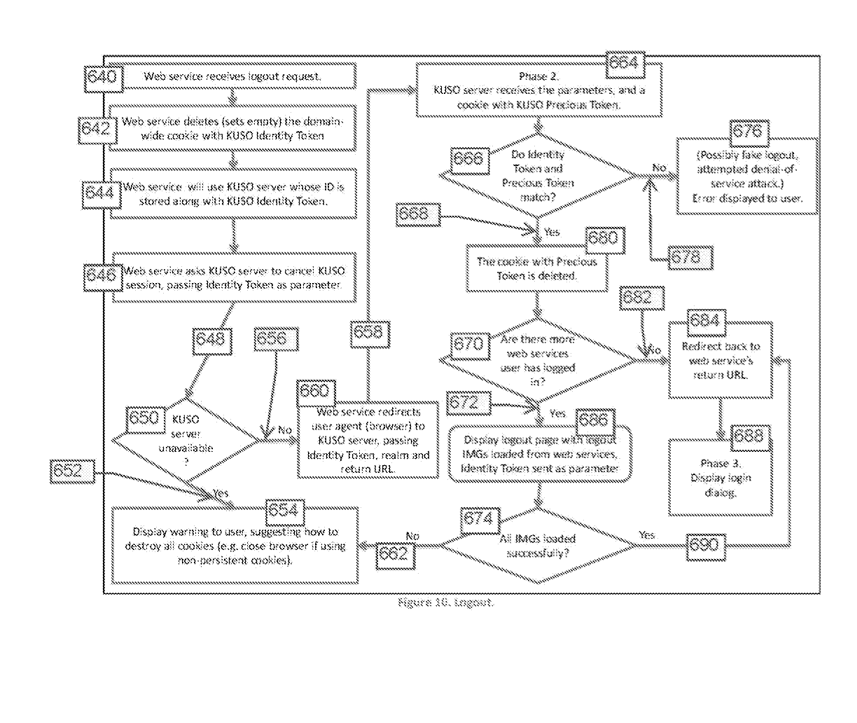

FIG. 10 shows, in accordance with an embodiment of the invention, the automated logout process. With KUSO, there is a single sign-off, which means when a user logouts from a KUSO-participating web service, the client would be logged out from all other KUSO-participating web services as well.

In step 640, one of the KUSO-participating web services receives a log-out request. The user may have logged into multiple KUSO-participating web services and this log out service may be received at any of the KUSO-participating web services, for example. In step 642, the web service that received the logout request deletes (sets empty) the domain-wide cookie with the KUSO identity token. In step 644, the web service that received the logout request uses the KUSO server whose ID is stored along with the KUSO identity token to service the logout request. If there are multiple KUSO servers, the KUSO server ID is stored earlier with the KUSO identity token and that KUSO server would be employed for the logout request service.

In step 646, the web service that received the logout request asks the KUSO server to cancel the KUSO session, and passes the KUSO identity token to the KUSO server using a secure channel. In step 650, it is ascertained whether communication with the KUSO server is possible (using, for example, the aforementioned hidden image technique or another suitable technique for ascertaining the availability of such web service server to KUSO server communication). If the KUSO server communication is not available or cannot be reached (path 652 and box 654), a warning would be displayed to the user that single logout is not available and the user is advised of the steps to manually log out of all KUSO-participating web services (e.g., by destroying all persistent cookies or by closing all browsers if non-persistent cookies are employed). The steps of box 654 necessary for safe manual logout of all KUSO-participating web services may vary depending on the cookies used for KUSO, the type of browser employed, etc.

On the other hand, if the KUSO server is available and can be reached by the web service that receives the logout request, the web service directs the user agent (browser) to the KUSO server (path 656 and step 660), and the web service passes to the client browser the identity token, the realm, and the return URL to later redirect the client browser to the web service.

In step 664, the KUSO server receives from the client browser parameters passed from the web service to the client browser in step 660 and also receives a from the client browser a cookie with the KUSO precious token. In step 666, the KUSO server checks to ascertain whether the identity token and the precious token match. If the identity token and the precious token fail to match, it could mean that, for example, a fake logout attempt is being attempted (e.g., someone lures the user to logout) or a denial of service (DOS) attack is underway. In this case, logout is not performed and an error message is displayed to the user instead (path 678 and box 676).

If the identity token and the precious token match (path 668 and box 680), the legitimate user is deemed to want to perform a single logout. In this case, the cookie with the KUSO precious token is destroyed at the client browser. In step 670, it is ascertained whether the user has logged into more KUSO-participating web services other than the web service that receives the logout request.

If the user has not logged into other KUSO-participating web services (other than the web service that receives the logout request), the browser is redirected back to the web service that receives the logout request using the return URL supplied earlier (path 682 and block 684). In block 688, the web service login dialog may be displayed again to allow the user to login again if the user desires to initiate another session with that web service.

On the other hand, if the user has logged into other KUSO-participating web services (other than the web service that receives the logout request), the method proceeds to path 672 and block 686 to display one or more logout pages with logout images loaded from individual KUSO-participating web services to inform the user of the fact that the user has also been automatically logged out of other KUSO-participating web services, and send the client browser the identity token as a parameter. This is to prevent an illegitimate source or third party from displaying these logout images if the user has not in fact logged out using the KUSO server.

In step 674, the browser checks to see if all logout images are successfully loaded. If any of the images cannot be loaded timely or successfully (path 662 and step 654), the method proceeds to step 654 to display a warning to the user that single logout is not successful and the user is advised of the steps to manually log out of all KUSO-participating web services (e.g., by destroying all persistent cookies or by closing all browsers if non-persistent cookies are employed). The steps of box 654 necessary for safe manual logout of all KUSO-participating web services may vary depending on the cookies used for KUSO, the type of browser employed, etc.

On the other hand, if all images are successfully loaded (path 690 and step 684), the browser is redirected back to the web service that receives the logout request using the return URL supplied earlier (path 682 and block 684). In block 688, the web service login dialog may be displayed again to allow the user to login again if the user desires to initiate another session with that web service (either with or without using KUSO).

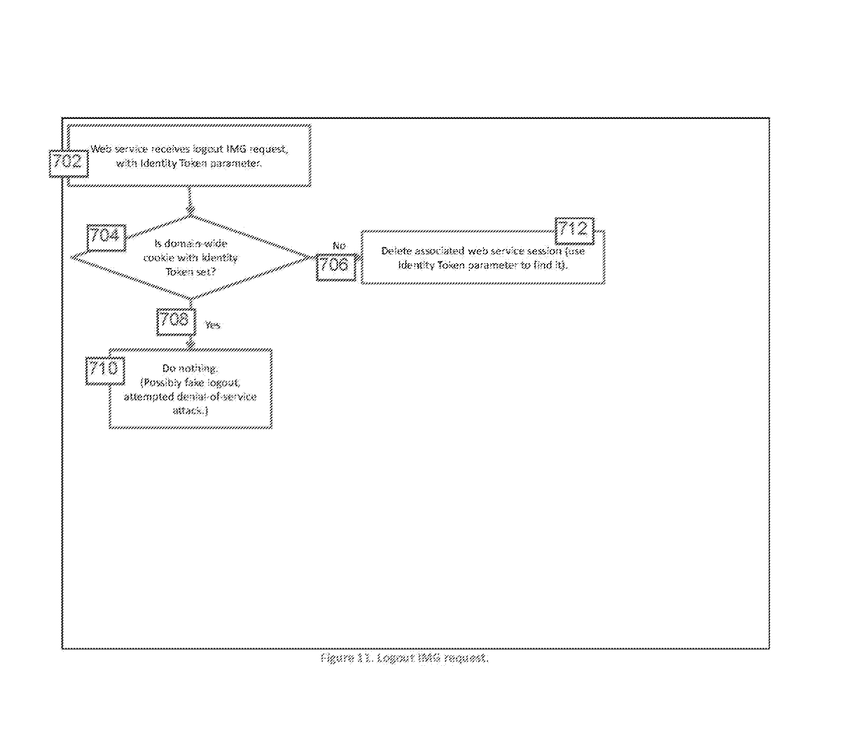

FIG. 11 shows, in accordance with an embodiment of the invention, the steps involved in servicing a logout IMG request. In step 702, a KUSO-participating web services receives a logout IMG request. The identity token is received as a parameter. In step 704, the method ascertains whether the domain-wide cookie with identity token is set. If not (path 706 and block 712), the associated web service session is deleted (the identity token parameter is employed to find such associated web service session).

On the other hand, if the domain-wide cookie with the identity token is set (path 708 and block 710), nothing is done since it is possible that a fake logout attempt is being made, or a denial of service (DOS) attack is underway.

Advantages of various embodiments of the invention include:

1) Compatibility: Integrates with various third-party directory/authentication services, i.e. the user can use Active Directory, Open Directory or another kind of LDAP server or more generally some kind of identity server for initial authentication to one of the servers, and then access the other servers seamlessly. Each participating server can use different set of authentication methods, e.g. one of the servers can support NTLM with Active Directory and LDAP protocol, while the others would support only LDAP.

2) Smart detection of KUSO availability: If the KUSO server isn't available to client (browser) or to participating server, normal authentication is used. Specifically, if KUSO's SSL certificate isn't trusted by the client, the user is offered a link to visit the server (and review and possibly manually accept the certificate). The detection is done whenever necessary, e.g. if a user brings his device to another network and KUSO server which was available is now blocked by firewall, normal authentication will be used.

3) Transparency: If user hasn't authenticated yet, he/she simply logs in as he/she would without KUSO. If authenticated (to one of the servers), user simply gets access to the requested service. Specifically, one can still use another authentication service or even local accounts defined within applications. Those local accounts don't get a KUSO session established, but unlike solutions which redirect all authentication requests to a central location, KUSO solution gives administrator a chance to login and disable KUSO in the participating server if necessary.

4) Separation of security realms: Users log in independently twice: to client interfaces, and to administration interfaces (actually applications may define an arbitrary set or realms). That improves security (admin session must be explicitly started and authenticated and can be terminated even when the client session continues).

5) Single log off. When user logs off any of the participating servers (in a particular security realm), his/her sessions with the other servers are terminated. Even if KUSO server is unavailable during logout, all users' sessions are invalidated (and terminated upon next request).

6) Security: The protocol is resistant against a range of passive and active attacks even from within the local network. SSL is used unless specifically configured not to. Participating server must authenticate itself with KUSO server (before it asserts users' identities). The KUSO session key is only transferred between the client and KUSO server, it is never sent to a (possibly fake) participating server, which thus in turn cannot steal the user's identity. Even logout requests are validated, thus an attacker cannot force a victim user to logout by luring them into loading an IMG from a KUSO server or KUSO-enabled web service.

7) High compatibility: The solution uses HTTP cookies, HTTP redirects and JavaScript on client. Neither browser plug-ins nor GSS-API support is required.

8) Robustness: One-time keys are used for selected purposes; that prevents some security issues, and unlike Kerberos this solution doesn't require 5-minutes sync of clocks.

9) Speed: The solution doesn't interfere with per-application sessions, thus it's not necessary to use it for each request, it's used only when necessary (when login would take place, i.e. upon first access to a particular server, or when a participating server has terminated the application session e.g. due to inactivity or due to service restart). This also improves the overall availability—KUSO server's temporary unavailability doesn't break anything.

10) Scaling: There's no all-to-all communication between participating servers. For initial and secondary logon, only one participating service and KUSO server are involved. Only logout is more expensive, KUSO service asks each service with user's sessions to terminate them.

While this invention has been described in terms of several preferred embodiments, there are alterations, permutations, and equivalents, which fall within the scope of this invention. If the term “set” is employed herein, such term is intended to have its commonly understood mathematical meaning to cover zero, one, or more than one member. The invention should be understood to also encompass these alterations, permutations, and equivalents. It should also be noted that there are many alternative ways of implementing the methods and apparatuses of the present invention. Although various examples are provided herein, it is intended that these examples be illustrative and not limiting with respect to the invention.

What is claimed is:

1. A single sign-on method for enabling a user to perform authenticated sign-on to a plurality of websites associated with a plurality of web services, comprising:
authenticating said user at a first website, said first website associated with a first web service;
communicating said authenticating from said first website to a server if said authenticating is successful; and
thereafter employing said server to authenticate said user if said user wishes to access a second website associated with a second web service different from said first web service.

2. An arrangement for facilitating single sign-on by a user to a plurality of websites associated with a plurality of web services, comprising:
a first web server, said first web server associated with a first website;
a single sign-on server, said single sign-on server communicating with said first web server if said first web server successfully authenticates said user; and
a second web server associated with a second website, said second web server communicating with said single sign-on server, responsive to said user wishing to access said second website, to ascertain that said user has previously been successfully authenticated.
